(19) United States
(12) Patent Application Publication
(10) Pub. No.: US 2021/0391624 A1
(43) Pub. Date: Dec. 16, 2021

(54) BATTERY MANAGEMENT DEVICE

(71) Applicants: Inventec (Pudong) Technology Corporation, Shanghai (CN); INVENTEC CORPORATION, Taipei (TW)

(72) Inventor: Yuan-Chang YANG, Taipei (TW)

(21) Appl. No.: 17/122,081

(22) Filed: Dec. 15, 2020

(30) Foreign Application Priority Data
Jun. 10, 2020 (CN) 202010524178.1

(51) Int. Cl. H01M 50/284; H01M 50/244; H01M 50/271; H01M 10/48; H01M 6/50

(52) U.S. Cl. CPC H01M 50/284; H01M 50/244; H01M 8/0438; H01M 10/48; H01M 6/5044; H01M 50/271

(57) ABSTRACT

The invention provides a battery management device. The battery management device includes a container, a battery, and an electronic assembly. The container has an airtight space. The battery is located within the airtight space. The electronic assembly is located within the airtight space and electrically connected to the battery. The electronic assembly includes an air pressure sensor, and the air pressure sensor is configured to sense an air pressure in the airtight space.

### CROSS-REFERENCE TO RELATED APPLICATIONS

This non-provisional application claims priority under 35 U.S.C. § 119(a) on Patent Application No(s). 202010524178.1 filed in China on Jun. 10, 2020, the entire contents of which are hereby incorporated by reference.

### BACKGROUND

### Technical Field of the Invention

The invention relates to a battery management device, more particularly to a battery management device having an air pressure sensor.

### Description of the Related Art

A fuel cell is an electrochemical device that can convert the hydrogen of fuel and oxidizing agent into electricity and water. Take a proton exchange membrane fuel cell (i.e., PEMFC) for instance, a PEMFC includes multiple battery cells, each battery cell includes a proton exchange membrane, two catalyst layers, two gas diffusion layers, an anode bipolar plate, and a cathode bipolar plate. The membrane, one catalyst layer, one gas diffusion, and the anode or cathode bipolar plate are sequentially arranged from the inner side to the outer side of the cell. And those components are tightly attached together.

Typically, the fuel cell is encapsulated in an airtight container to constitute a fuel cell battery. The manufacture of the fuel cell battery involves airtightness testing on the container to ensure the quality. However, the traditional fuel cell batteries do not contain a proper means to find air leaks, such that the user may unawarely use an abnormal battery device.

### SUMMARY OF THE INVENTION

The invention provides a battery management device that can detect the abnormal condition in time.

One embodiment of the disclosure provides a battery management device. The battery management device includes a container, a battery, and an electronic assembly. The container has an airtight space. The battery is located within the airtight space. The electronic assembly is located within the airtight space and electrically connected to the battery. The electronic assembly includes an air pressure sensor, and the air pressure sensor is configured to sense an air pressure in the airtight space.

According to the battery management device as discussed above, the air pressure sensor enables real-time monitoring of the internal pressure of the battery management device so as to monitor the real-time condition of the battery management device during the operation.

### BRIEF DESCRIPTION OF THE DRAWINGS

The present invention will become better understood from the detailed description given herein below and the accompanying drawings which are given by way of illustration only and thus are not intending to limit the present invention and wherein:

FIG. 1 is a perspective view of a battery management device according to one embodiment of the invention; and

FIG. 2 is an exploded view of the battery management device in FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the following embodiments are disclosed by the figures, and some practical details are described in the following paragraphs, but the present invention is not limited thereto. Furthermore, for the purpose of illustration, some of the structures and components in the figures are simplified, and wires, reference lines or buses are omitted in some of the figures.

Moreover, the terms used in the present invention, such as technical and scientific terms, have its own meanings and can be comprehended by those skilled in the art, unless the terms are additionally defined in the present invention. That is, the terms used in the following paragraphs should be read on the meaning commonly used in the related fields and will not be overly explained, unless the terms have a specific meaning in the present invention.

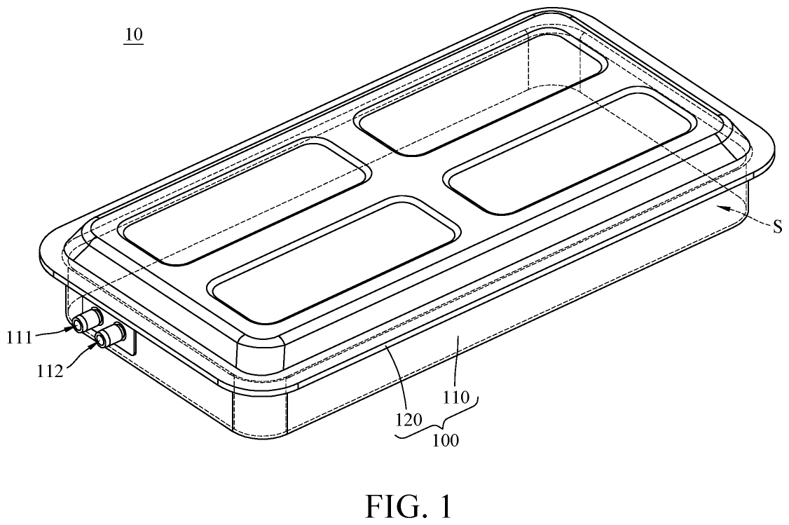

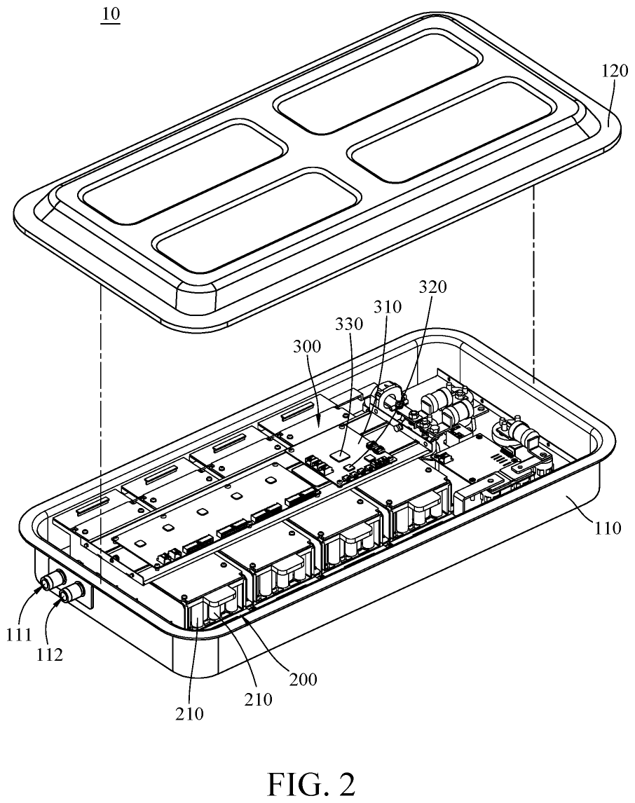

Referring to FIGS. 1 and 2, there are shown a perspective view of a battery management device 10 according to one embodiment of the invention and an exploded view of the battery management device 10 in FIG. 1.

In this embodiment, the battery management device 10 includes a container 100, a battery 200, and an electronic assembly 300.

The container 100 includes an accommodation casing 110 and a cover 120. The cover 120 covers the accommodation casing 110, such that the accommodation casing 110 and the cover 120 together form an airtight space S therebetween. The battery 200 and the electronic assembly 300 are arranged in the accommodation casing 110 and located within the airtight space S. In addition, the accommodation casing 110 of the container 100 has a gas inlet 111 and a gas outlet 112. The gas inlet 111 and the gas outlet 112 is configured for a connection of a gas regulator (not shown), such as a pump. The gas regulator can suck gas out of the airtight space S or inject gas into the airtight space S.

Note that the locations of the gas inlet 111 and the gas outlet 112 can be changed as required; in some other embodiment, the gas inlet 111 and the gas outlet 112 may be formed on the cover.

In this embodiment, the airtight space S contains only one gas being one kind of noble gas, such as nitrogen, facilitating the testing on the battery 200. The testing will be discussed in detail in later paragraphs. In addition, the airtight space S is in a predetermined pressure higher than one atmosphere. The pressure difference is to prevent external air or liquid from entering into the container 100 to effect the operation of the battery 200 if there is a crack existing in the container 100.

The battery 200 is located in the airtight space S. The battery 200 includes a plurality of battery cells 210. The battery cells 210 are electrically connected to one another in series or parallel connection.

The electronic assembly 300 is located in the airtight space S and electrically connected to the battery 200. The electronic assembly 300 includes a circuit board 310, an air pressure sensor 320, and a controller 330. The circuit board 310 is stacked on a side of the battery 200. The air pressure sensor 320 and the controller 330 are disposed on a side of the circuit board 310 away from the battery 200. The controller 330 is electrically connected to the air pressure sensor 320. The air pressure sensor 320 is configured to sense the air pressure in the airtight space S.

When the air pressure sensor 320 detects that the air pressure in the airtight space S is higher than the predetermined pressure, the controller 330 will determine that the battery 200 is in an abnormal condition. Specifically, when the battery 200 operates in a normal condition, the air pressure of the airtight space S shall be the same as the predetermined pressure. However, when the battery 200 goes abnormal and leaks gas resulted from its chemical reaction, the air pressure of the airtight space S increases to be higher than the predetermined pressure. The air pressure sensor 320 can detect the pressure increase, and then the pump can suck out the internal gas existing in the airtight space S. Since the gaseous substances being sucked out of the airtight space S not only contains nitrogen but also contains those leaked from the battery 200, thus a simple gas analysis can determine the abnormal condition of the battery 200. For this reason, the airtight space S, as predetermined, shall only contain one kind of gas (e.g., nitrogen) for the ease of precisely determine the abnormal condition of the battery 200.

On the other hand, when the air pressure sensor 320 detects that the air pressure in the airtight space S is lower than the predetermined pressure, the controller 330 determines that the container 100 has an abnormal airtightness; that is, the container 100 may be not airtight, and the container 100 may have the gas leak issue.

In this embodiment, the air pressure sensor 320 enables real-time monitoring of the internal pressure of the battery management device 10 so as to monitor the real-time condition of the battery management device 10 during the operation.

According to the battery management device as discussed above, the air pressure sensor enables real-time monitoring of the internal pressure of the battery management device so as to monitor the real-time condition of the battery management device during the operation.

In addition, the only one gas contained in the airtight space shall be one kind of noble gas (e.g., nitrogen). Therefore, if another gas exists in the airtight spaces, the maintainer can determine the abnormal condition of the battery.

In one embodiment of the invention, the battery management device can be applied in a vehicle, such as a self-driving vehicle, an electric vehicle, or a semi-self-driving vehicle and so on.

It will be apparent to those skilled in the art that various modifications and variations can be made to the present invention. It is intended that the specification and examples be considered as exemplary embodiments only, with a scope of the invention being indicated by the following claims and their equivalents.

What is claimed is:

1. A battery management device, comprising:
a container, having an airtight space;
a battery, located within the airtight space; and
an electronic assembly, located within the airtight space and electrically connected to the battery, wherein the electronic assembly comprises an air pressure sensor, and the air pressure sensor is configured to sense an air pressure in the airtight space.

2. The battery management device according to claim 1, wherein the airtight space is in a predetermined pressure higher than one atmosphere.

3. The battery management device according to claim 1, wherein the airtight space contains only one gas being one kind of noble gas.

4. The battery management device according to claim 3, wherein the only one gas is nitrogen.

5. The battery management device according to claim 1, wherein the container has a gas inlet and a gas outlet, and the gas inlet and the gas outlet are configured for a connection of a gas regulator.

6. The battery management device according to claim 1, wherein the battery comprises a plurality of battery cells, the plurality of battery cells are electrically connected to each other.

7. The battery management device according to claim 1, wherein the electronic assembly further comprises a circuit board, the circuit board is stacked on a side of the battery, and the air pressure sensor is disposed on a side of the circuit board away from the battery.

8. The battery management device according to claim 1, wherein the container comprises an accommodation casing and a cover, the cover covers the accommodation casing, the cover and the accommodation casing together form the airtight space therebetween, and the battery and the electronic assembly are arranged in the accommodation casing and located within the airtight space.

9. The battery management device according to claim 1, wherein the electronic assembly further comprises a controller, the controller is electrically connected to the air pressure sensor; when the air pressure sensor detects that the air pressure in the airtight space is higher than a predetermined pressure, the controller determines the battery is in an abnormal condition.

10. The battery management device according to claim 9, wherein when the air pressure sensor detects that the air pressure in the airtight space is lower than a predetermined pressure, the controller determines that the container has an abnormal airtightness.
